(19) United States
(12) Patent Application Publication
(10) Pub. No.: US 2013/0132542 A1
(43) Pub. Date: May 23, 2013

(54) Method and System for Effective BGP AS-Path Pre-pending

(71) Applicant: Ying Zhang, San Jose, CA (US)

(72) Inventor: Ying Zhang, San Jose, CA (US)

(73) Assignee: Telefonktiebolaget L M Ericsson (publ), Stockholm (SE)

(21) Appl. No.: 13/300,372

(22) Filed: Nov. 18, 2011

(51) Int. Cl. G06F 15/173

(52) U.S. Cl. 709/223

(57) ABSTRACT

A method implemented in a network element to determine an autonomous system (AS) path pre-pending (ASPP) vector for an AS of the network element that accounts for AS business relationship induced policies and global impact of ASPP decisions by using comparable paths between AS in a network for application of network management strategies, the comparable paths grouped by path types defined by local preference polices, the method including gathering AS level topological data for the network, categorizing AS link relationships in the topological data, computing the comparable paths for each AS pair, and applying any one of a load balancing process, back-up path provisioning process or traversal avoidance process to the comparable paths to determine an ASPP vector for the AS of the network element.

### FIELD OF THE INVENTION

The embodiments of the invention relate to a method and system for improved autonomous system (AS) path pre-pending. Specifically, the embodiments relate to a method and system to select and implement an AS path pre-pending (ASPP) strategy that accounts for AS business relationship induced policies and the global impact of ASPP.

### BACKGROUND

An autonomous system (AS) is a single administrative domain that operates on a set of prefixes, routers, and network devices. The administrative domain can be under the control of one or more network operators. Each AS defines its own internal routing policy, and can define separate and distinct routing policies for communication with neighboring autonomous systems. A network operator can be an Internet service provider or a very large organization with independent connections to multiple external networks. The system for managing autonomous systems has been defined in RFC 1930.

A unique autonomous system number (ASN) is allocated to each AS for use in border gateway protocol (BGP) routing. The ASN uniquely identifies each network on the Internet. The Internet Assigned Numbers Authority (IANA) designates ASNs to requesting entities. The IANA has designated AS numbers 64512 through 65534 to be used for private purposes. The ASNs 0, 59392-64511, and 65535 are reserved by the IANA and should are not used in any routing environment. ASN 0 can be used to label non-routed networks. All other ASNs (1-54271) are subject to assignment by IANA. RFC 4893 introduced 32-bit AS numbers, which IANA has begun to allocate. These numbers are written either as simple integers, or in the form x.y, where x and y are 16-bit numbers. Numbers of the form 0.y are the old 16-bit AS numbers, 1.y numbers and 65535.65535 are reserved, while all other AS numbers are available for allocation by the LANA.

The Border Gateway Protocol (BGP) is a protocol implemented in network elements such as routers that disseminates information on how to route data traffic on the Internet. The BGP is utilized to maintain a table of Internet Protocol ‘prefixes’ that define network reachability among autonomous systems (AS). BGP is a path vector protocol as BGP announcement message contains a set of ASes along the path. BGP enables routing decisions based on path, network policies and rulesets. BGP defines a process by which the implementing network elements exchange update messages that enable the update of the BGP routing tables with paths to each of the reachable prefix.

### SUMMARY

A method implemented in a network element to determine an autonomous system (AS) path pre-pending (ASPP) vector for an AS of the network element that accounts for AS business relationship induced policies and global impact of ASPP decisions by using comparable paths between autonomous systems in a network for application of network management strategies, the comparable paths grouped by path types defined by local preference polices, the method comprising the steps of: gathering AS level topological data for the network from a border gateway protocol (BGP) table of the network element; categorizing AS link relationships in the topological data as peer links, customer links and provider links; computing the comparable paths for each AS pair, the comparable paths for an AS pair sharing a path type defined by the local preference policies and a best path amongst the comparable paths for the AS pair being affected by ASPP; and applying any one of a load balancing process, back-up path provisioning process or traversal avoidance process to the comparable paths to determine an ASPP vector for the AS of the network element.

A network element to determine an autonomous system (AS) path pre-pending (ASPP) vector for an AS of the network element that accounts for local preference policies and global impact of ASPP decisions by using comparable paths between autonomous systems in a network for application of network management strategies, the comparable paths grouped by path types defined by the local preference polices, the method comprising the steps of: an ingress module to receive data traffic from the network; an egress module to transmit data traffic on the network; and a network processor coupled to the ingress module and egress module the network processor to execute a BGP module and a centralized ASPP module, the BGP module to maintain a border gateway protocol (BGP) routing table and exchange BGP update messages with other network elements, the ASPP module to execute an AS topological module that gathers AS level topological data for the network from the BGP table, a link categorization module to categorize AS link relationships in the topological data as peer links, customer links and provider links, and a comparable path module to compute the comparable paths for each AS pair, the comparable paths for an AS pair sharing a path type defined by the local preference policies and a best path amongst the comparable paths for the AS pair being affected by ASPP, the ASPP module to execute any one of a load balancing module, back-up path provisioning module or traversal avoidance module to the comparable paths to determine an ASPP vector of the AS of the network element.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram of one embodiment of example AS-Paths in BGP announcements demonstrating AS pre-pending use.

FIG. 2 is a diagram of an example network in which the automated and systematic ASPP method and system can be implemented.

FIG. 3 is a diagram of one embodiment of a network element implementing the method and system of automatic and systematic ASPP.

FIG. 4 is a flowchart of one embodiment of the process implemented by the automatic and systematic ASPP method and system.

FIG. 5 is a flowchart of one embodiment of a process for identifying comparable paths using the topological information.

FIG. 6 is a diagram of a process for determining paths for all nodes in a network to a target AS (t).

FIG. 7 is a flowchart of one embodiment of the process for determining an ASPP vector for load balancing.

FIG. 8 is a diagram of another embodiment of the load balancing process expressed in a more mathematical example.

FIG. 9 is a flowchart of one embodiment of a process for traversal avoidance.

FIG. 10 is a flowchart of one embodiment of a process for back-up path provisioning.

FIG. 11 is a diagram of another embodiment of a padding vector computation for back-up path and avoiding AS.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The operations of the flow diagrams in the attached Figures will be described with reference to the exemplary embodiments shown in the attached Figures. However, it should be understood that the operations of the flow diagrams can be performed by embodiments of the invention other than those discussed with reference to the attached Figures, and the embodiments discussed with reference to the diagrams in the attached Figures can perform operations different than those discussed with reference to the flow diagrams of the attached Figures.

The techniques shown in the figures can be implemented using code and data stored and executed on one or more electronic devices (e.g., an end station, a network element, etc.). Such electronic devices store and communicate (internally and/or with other electronic devices over a network) code and data using non-transitory machine-readable or computer-readable media, such as non-transitory machine-readable or computer-readable storage media (e.g., magnetic disks; optical disks; random access memory; read only memory; flash memory devices; and phase-change memory). In addition, such electronic devices typically include a set of one or more processors coupled to one or more other components, such as one or more storage devices, user input/output devices (e.g., a keyboard, a touch screen, and/or a display), and network connections. A ‘set,’ as used herein, refers to any positive whole number of items. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software, that communicatively interconnects other equipment on the network (e.g., other network elements, end stations, etc.). Some network elements are “multiple services network elements” that provide support for multiple networking functions (e.g., routing, bridging, switching, Layer 2 aggregation, session border control, multicasting, and/or subscriber management), and/or provide support for multiple application services (e.g., data, voice, and video). Subscriber end stations (e.g., servers, workstations, laptops, palm tops, mobile phones, smart phones, multimedia phones, Voice Over Internet Protocol (VOIP) phones, portable media players, GPS units, gaming systems, set-top boxes (STBs), etc.) access content/services provided over the Internet and/or content/services provided on virtual private networks (VPNs) overlaid on the Internet. The content and/or services are typically provided by one or more end stations (e.g., server end stations) belonging to a service or content provider or end stations participating in a peer to peer service, and may include public web pages (free content, store fronts, search services, etc.), private web pages (e.g., username/password accessed web pages providing email services, etc.), corporate networks over VPNs, IPTV, etc. Typically, subscriber end stations are coupled (e.g., through customer premise equipment coupled to an access network (wired or wirelessly)) to edge network elements, which are coupled (e.g., through one or more core network elements to other edge network elements) to other end stations (e.g., server end stations).

The embodiments of the present invention provide a method and system for avoiding the disadvantages of the prior art. The disadvantages of the prior art are that previous methods for computing an optimal autonomous system path pre-pending (ASPP) vector all ignored policy induced preferences on path selections based on AS business relationships. Network operators today even rely on a trial-and-error methodology. For instance, network operators of an AS usually prefer to use paths learned from its customers than those learned from its peers or providers. Previous methods only consider a single objective, i.e. load-balancing. Current methods do not offer a systematic way to implement ASPP. Currently, network operators implement ASPP by trial-and-error, which may take some time to converge to a desirable ASPP configuration and in the meantime forces real customer traffic to experiment with different paths that may not be appropriate or efficient.

The embodiments of the invention overcome these disadvantages of the prior art. The disadvantage of the prior art are avoided by taking AS relationship into consideration, which is more realistic and thus more accurate in predicting path selection. The method has the intelligence to scale to the size of the global Internet. The method and system can cope with at least three different objectives: performing load-balancing, provisioning back-up paths, and bypassing a particular AS. The method and system enable a network operator to practice ASPP systematically for a range of designated purposes.

### AS-Path Pre-Pending

BGP is the de-facto inter-domain routing protocol for the current Internet. used for adjacent routers or ASes to disseminate routing information across the AS border. Each BGP announcement contains a set of attributes. One of the important mandatory attributes of these BGP announcement messages is the AS-PATH, which recording the sequence of ASes through which the BGP announcement message has passed starting with the source AS of the BGP announcement message. As a BGP announcement message traverses the Internet, border routers in each AS add (pre-pend) the AS number (ASN) of the AS in which the border router belongs. This ASN is added to the beginning or front of the AS-PATH attribute. BGP is based on a distance vector algorithm, meaning that the path with a shorter path is generally preferred. BGP is also a policy-based routing protocol. The network operators can configure BGP in certain ways to influence the path selection both locally and globally.

AS path pre-pending (ASPP) is one of these traffic engineering approaches. Instead of pre-pending its ASN once to the path, an AS adds its own AS number multiple times to artificially increase the length of the AS path. Assume a BGP announcement for prefix p, prefix p identifying the source of the BGP announcement, has an AS-PATH {AS₁,AS₂* . . . ASₖ}, where * stands for one more occurrence of AS₂. The longer the AS path that is announced to the external BGP neighbor, the less likely the path will be adopted as the best path by other ASes to reach p, indicating that less incoming traffic will be received from that neighbor, because other paths are more likely to be selected to reach p.

When manipulating AS paths in this manner, the only valid AS number to pre-pend to the AS-PATH attribute is the AS number of the AS of the router that is about to send the BGP announcement to a neighbor AS. Pre-pending any other AS number is considered as misbehaving or inconsistent with BGP. The AS of the router that pre-pends its AS number multiple times (i.e., more than once) into the AS-PATH attribute is referred to as a pre-pending AS or padding AS.

ASPP can be classified into two types, source pre-pending and intermediary pre-pending, based on the location of the pre-pending AS. Source pre-pending refers to the case where the AS pre-pending is performed by the originating AS of a BGP announcement message or the owner of the prefix for the BGP announcement message. Intermediary pre-pending refers to pre-pending that is performed by other non-originating ASes along the path of a BGP announcement message.

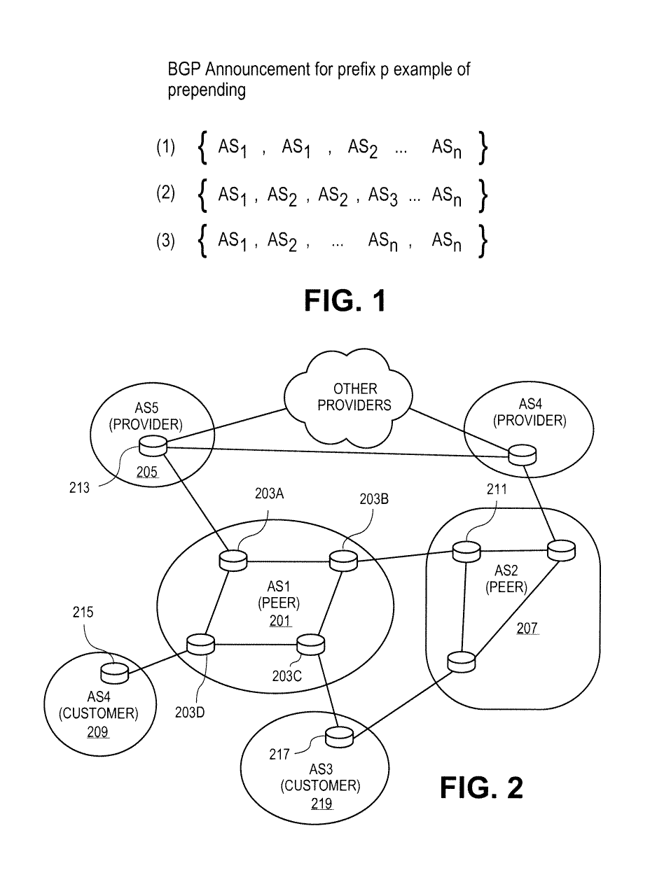

FIG. 1 is a diagram of one embodiment of example AS-PATH attributes demonstrating pre-pending. The first example path (1) illustrates pre-pending by the sender of the BGP announcement, where the sender has pre-pended its ASN (AS₁) twice instead of a single instance of the ASN being added to the AS-PATH attribute. The second example path (2) illustrates pre-pending by an intermediate AS along the path of the BGP announcement, where the router of that AS pre-pended its ASN (AS₂) twice instead of a single instance of the ASN being added to the AS-PATH attribute. The third example path (3) illustrates pre-pending by an originating AS, where the router of that AS pre-pended its ASN (ASₙ) twice instead of a single instance of the ASN being added to the AS-PATH attribute.

### ASPP and the BGP Decision Process

Through ASPP, an AS can influence the path selection process of other AS's and thus affect the distribution of traffic flowing into the AS. When multiple paths are available, BGP follows the decision process in Table I to select the best path to a particular destination.

TABLE I

1. Ignore if the next hop is unreachable
2. Highest local preference
3. Shortest AS path
4. Lowest origin type
5. Lowest Multiple-Exit-Discriminator (MED) value among
routes from the same AS
6. eBGP learned route over iBGP learned route
7. Lowest IGP cost (hot-potato)
8. Lowest router ID

The steps in path selection process are summarized below as shown in Table I.

1. Unreachable hops: Those paths with unreachable next hops are ignored.

2. Highest local preference: prefer paths with the highest local preference, assigned by the import policy and conveyed to other routers via interior BGP.

3. Shortest AS path: Prefer paths with the shortest AS path length, as conveyed in the BGP advertisement.

4. Lowest origin type: Prefer routes with the lowest value of their ORIGIN attribute.

5. Lowest MED value: Prefer routes with the lowest MULTI_EXIT_DISC (multi-exit discriminator or MED) value.

6. eBGP over iBGP: Prefer paths learned via eBGP over paths learned via iBGP, since leaving the AS directly is preferable to traveling through the AS.

7. Lowest IGP metric: Prefer paths with the smallest intradomain (IGP) metric to reach the next hop. This enables each router to select its “closest” exit point.

8. Lowest router ID: Prefer the path learned from a router with the lowest identifier, as conveyed during BGP session establishment. This step breaks ties between paths that are equally good after the previous steps have been applied.

Therefore, the effectiveness of any AS-Path pre-pending is limited by the use of local routing policies expressed through the Local Preference attribute of the BGP announcement message, which has a higher priority in the decision process. A common local preference policy is that, for the same destination prefix, an AS prefers to send traffic through a customer link rather than a peering link, and it prefers to use a peering link rather than a provider link. This is because the network operator of an AS does not need to pay for the traffic going through its customer link but has to pay for traffic traversing the provider links.

One way for a network operator to implement this policy is using the local preference attribute in the announcement. Another way to implement the policy is using selective BGP announcements. It is generally recommended that the routers of the AS should not announce paths learned from its providers/peers to other providers and peers, in order to guarantee that the AS does not provide transit service between its providers or its peers. This is often known as the “valley-free” policy.

### Inter-Domain Traffic Engineering

Traffic engineering (TE) is used by network operators to control the distribution of traffic in response to changes in the condition of a network. Traffic engineering techniques can involve adjusting the configuration of the routing protocols running on the router within the control of a network operator. In the inter-domain traffic engineering, most traffic engineering techniques still rely on network operators to make manual changes in the routing policies, without a good understanding of the impact of these policies on other domains.

Inter-domain traffic engineering encompasses a set of techniques designed to influence the distribution of traffic over the network. Equipment failures and changes in routing policies in neighboring domains can trigger sudden shifts in the flow of traffic. Flash crowds caused by special events and new applications can also cause significant changes in the load on the network. Network failures and traffic fluctuations degrade user performance and lead to inefficient use of network resources. Network operators adapt to changes in the distribution of traffic by adjusting the configuration of the routing protocols running on their routers. Additionally, routing configuration changes are often necessary after deploying new routers and links.

Lacking a systematic approach for inter-domain traffic engineering, network operators make manual changes in the routing policies without a good understanding of the effects on the flow of traffic or the impact on other domains. Ultimately, this ad hoc approach to inter-domain traffic engineering must evolve into mature, well-tested guidelines and mechanisms. The embodiments of the methods and system described herein advance automated inter-domain traffic engineering, focusing on the AS path pre-pending functions.

### BGP Community Attributes

BGP supports transit policies via controlled distribution of routing information. BGP communities are attribute tags that can be applied to incoming or outgoing prefixes to achieve some common goal (as defined in RFC 1997). While it is common to say that BGP allows an administrator to set policies on how prefixes are handled by network operators, this is generally not possible, strictly speaking. For instance, BGP natively has no concept to allow one AS to tell another AS to restrict advertisement of a prefix to only North American peering customers. Instead, a network operator generally publishes a list of well-known or proprietary communities with a description for each one, which essentially becomes an agreement of how prefixes are to be treated. Examples of common communities include local preference adjustments, geographic or peer type restrictions, denial of service (DoS) avoidance (black holing), and AS pre-pending options. A network operator might configure its AS such that any paths received from customers with community XXX:500 will be advertised to all peers (default) while community XXX:501 will restrict advertisement to North America. A customer AS adjusts their router configuration to include the correct community(ies) for each path, and the provider AS is responsible for controlling who the prefix is advertised to. The end user has no technical ability to enforce correct actions being taken by the provider AS, though problems in this area are generally rare and accidental.

It is a common tactic for end customer AS's to use BGP communities (usually ASN:70,80,90,100) to control the local preference the provider AS assigns to advertised paths instead of using MED (the effect is similar). It should also be noted that the community attribute is transitive, but communities applied by the customer very rarely become propagated outside the next-hop AS.

### Basic AS-PATH Pre-Pending

ASPP can be used for local load balancing and for back-up path provisioning. For the purpose of load balancing, network operators increase the instances of padding for an advertised path in a trial-and-error fashion until the AS-Path length is sufficient to reduce the load of that ingress link to an expected value. For the purpose of provisioning back-up paths, the degree of padding is usually large enough so that the back-up path will not be adopted as best path unless there is a failure in other primary paths.

### Automated and Systematic ASPP

AS-Path pre-pending can be used for traffic distribution shaping across multiple providers. The network operators need to determine how many ASNs to pad for each ingress link. The set of numbers of padding instances for all links is called the ASPP vector. The ASPP vector can be tracked per prefix. Without the embodiments of the method and system described herein, network operators must determine the ASPP values in a trial-and-error manner. The method and system consider the global impact of an ASPP decision. Moreover, the method and system consider the impact of realistic local preference policies on ASPP's effectiveness.

This method and system compute a strategy for path pre-pending. The output can be implemented either by the management system of the AS itself or by the management system of the AS's providers, which can perform ASN pre-pending on behalf of its customers. Thus, the method and system can use BGP community attributes to achieve a desired mechanism for pre-pending.

The method and system calculates optimal ASPP vectors taking into consideration the local policy preference based on AS commercial relationships. Instead of focusing on the impact of traffic distribution on local ingress links, the method and system predicts the path adaptation on all other ASes in the Internet. Thus, the method and system is able to estimate the global impact of any padding action. The method and system extends the objectives of ASPP beyond load-balancing. The method and system support three objectives, balancing the load, provisioning a back-up path, and bypassing a specific AS. By passing a specific AS is needed when an origin AS does not want a particular AS along the path for traffic destined to it. The method and system support implementation by a provider AS for itself or using the BGP community attribute to support it for customer AS's.

FIG. 2 is a diagram of an example network in which the automated and systematic ASPP method and system can be implemented. The embodiments of the method and system described herein are described in relation to implementation within an example network AS1 201 which includes a set of routers 203A-D implementing BGP. eBGP is utilized to communicate routing and reachability information with the routers 213, 211 and 209 of neighboring AS's 205, 207, 209 and 219. iBGP is utilized to communicate routing and reachability information amongst the routers 203A-D.

The routers 203A-D can be any type of network devices capable of implementing BGP and that share links with internal and external routers. Similarly, external routers 205, 211, 209 and 219 can be any type of networking devices capable of implementing BGP and that share links with AS1 201. Links between routers can be any type of communication medium including wired and wireless communication links including fiber optic links, satellite links, RF links, Ethernet links and similar types of link technologies.

Each AS can include any number of computing devices in any type of network configuration such as a ring, mesh, tree or similar configuration. An AS can include any number of computing devices including any number of intermediate network elements between border routers. The AS's in the network can have any set of business relationships with their respective neighbor AS. These business relationships t can determine the terms of data exchange (i.e., cost of data transfers between ASes). In relation to AS1, AS3 217 and AS4 209 are customers indicating that they pay ASI for data traffic traversal of AS1 in each direction. AS2 i207 is a peer network where a contract determines the rates for data exchange between two AS's. AS5 205 is a provider network that AS 1 pays for data traffic traversing the provider AS5 205 destined for AS1 201 or its customers AS4 209 and AS3 219.

The network illustrated in FIG. 2 is provided by way of example to help clarify the context in which the method and system described herein functions. The method and system can be implemented in any network element 203A-D or similar network elements in a network similar to the illustrated network. One skilled in the art would understand that the illustrated network is a simplification of the architecture of the Internet and that the principles and structures described herein are applicable to the Internet and similar networks.

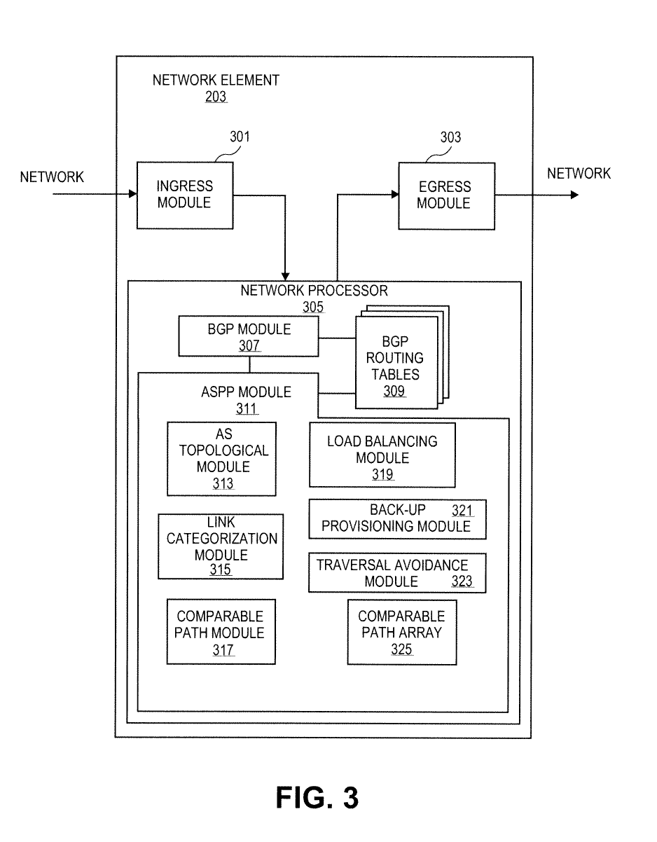

FIG. 3 is a diagram of one embodiment of a network element implementing the method and system of automatic and systematic ASPP. The network element 203 can be a router or similar networking device. The network element 203 can include an ingress module 301 and egress module 303. The ingress module 301 and egress module 303 can handle the physical layer and transport layer processing of incoming and outgoing data traffic, respectively. The incoming data traffic is forwarded to the network processor for further processing including layer 3 processing. Data traffic is received from the network processor 305 to be forwarded on any port and communication link of the network element.

The network element 305 can be any type of processing devices or set of processing devices for handling data traffic processing and routing. The network processor 305 can implement a range of functions and services as integrated circuit components or in software executed by the network element 305. The components can include a BGP module 307, a set of BGP routing tables 309, and an ASPP module 311.

The BGP module 307 handles the maintenance of the BGP routing tables 309 and the processing of the BGP announcements received from neighboring routers as well as the forwarding of these BGP announcements amongst other BGP function. The BGP module 307 stores and updates routing information derived from the BGP announcements in the BGP routing tables 309. These BGP routing tables 309 can be stored in working memory within the network processor 305 or in memory external to the network processor 305. The BGP module 307 can also communicate with the ASPP module to determine an ASPP value for outgoing BGP announcement messages that affect a desired traffic engineering goal configured for the AS in which the network operator has specified and which is implemented by the ASPP module 311. This configuration can be stored within the ASPP module 311, the network processor 305, the network element 203 or at an external location accessible to the network element 203.

The ASPP module 311 can include an AS topological module 313, a link categorization module 315, a comparable path module 317, a load balancing module 319, a back-up provisioning module 321, a traversal avoidance module 323 and a comparable path array 325. These modules can be separated modules in communication with the ASPP module 311, integrated in any combination with the ASPP module 311 or BGP module 307 or similarly Implemented. The modules can be discrete hardware components such as integrated circuits or can be software executed by the network processor 305.

The AS topological module 313 collects routing information from the BGP routing table 309 to generate a topological map of the network in which the network element 203 resides. The AS topological module 313 can also optionally retrieve routing and reachability data from an external server that collect BGP announcement data. This topological map can be used to calculate paths across the topological map that are comparable.

The link categorization module 315 utilizes the topological map generated by the AS topological module 319 and categorizes the relationship associated with each link between the AS's in the topological map. The links can be categorized relative to the AS implementing the system and method. The links can be provider links that connect the AS to a provider AS. The links can be customer links that connect the AS to a customer AS. The links can be peer links that connect the AS to other peer AS's. This information can be added to the topological map generated by the AS topological module 313 or can be separately stored.

The comparable path module 315 calculates a set of comparable paths for a particular prefix. These comparable paths have similar characteristics in regarding to meeting local preferences and similar BGP path selection criteria. Comparable paths can also be considered as those paths where the modification of the relative ASPP for these path will affect the routing of data traffic. The identification of comparable paths is discussed in further detail herein below. These comparable paths are stored in the comparable path array 325 for use by the load balancing module 319, back-up provisioning module 321 and traversal avoidance module 323.

The load balancing module 319 utilizes the comparable path array 325 to select an ASPP vector to spread data traffic traversing the AS of the network element 203 according to the configuration of the network operator. The back-up provisioning module 321 utilizes the comparable path array 325 to select an ASPP vector to ensure that one path is preferred over another path that is to serve as a back-up to the first path. The traversal avoidance module 323 utilizes the comparable path array 325 to select an ASPP vector to direct data traffic away from paths that traverse a particular AS defined by the configuration information. The functions of these traffic engineering modules 319, 321 and 323 are described in further detail below.

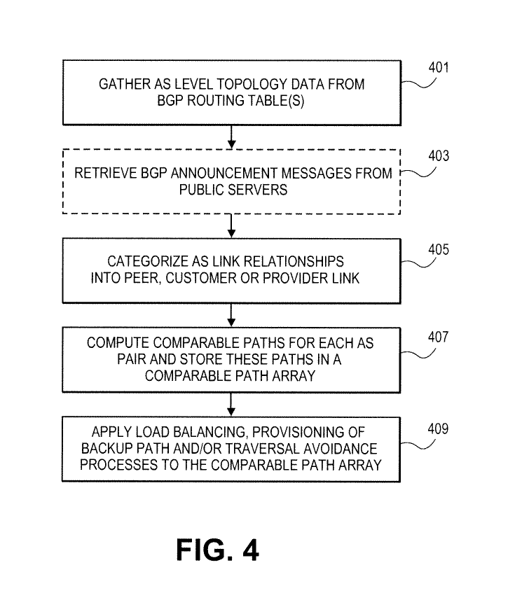

FIG. 4 is a flowchart of one embodiment of the process implemented by the automatic and systematic ASPP method and system. In one embodiment, the process is initiated by gathering AS level topological data from the BGP routing tables of the network element (Block 401). Any amount of information can be gathered about the AS level topology from the BGP routing tables to create a view relative to the AS of the network element, as a single view from a single AS may not be complete.

In one embodiment, the process optionally retrieves BGP updates or table snapshots from a public server storing these messages (Block 403). To obtain a complete view of the AS topology, the process draws on BGP announcement messages from a publicly-available servers. These public servers collect announcement messages by establishing eBGP sessions with routers in participating ASes. The logs contain the best path from all the peering routers. In one embodiment, both the routing table and public server data can be used. The process can start with an initial BGP routing table and apply the stream of announcement messages to this start data to construct a view of the routing table at each point in time.

The process can continue by categorizing AS link relationships for the topological information. Inferring these AS relationships prepare them for later simulation. The process can infer the AS relationships based on a heuristic that the size of an AS is typically proportional to its degree in the AS graph. This embodiment of the process classifies an interconnected AS pair into having a provider, customer, or peering relationship. In other embodiments, these relationships can be configured by an administrator of the network element.

The process can also compute comparable paths using the topology data and link categorization to predict the path selection on each AS (Block 407). During this process, a search is made for the best strategy for a given objective. The process infers AS paths by finding the shortest policy paths (i.e., the paths that conform to AS relationships) in an AS graph obtained from BGP tables at multiple vantage points. The resulting paths identified by the process are stored in the comparable path array.

The process outputs these comparable arrays for use by any of a selected set of traffic engineering processes to be applied including a load balancing, provisioning of back-up path, and/or a traversal avoidance process (Block 409). This process considers the effectiveness of the AS-Path pre-pending technique together with the effect of general routing policies. The local routing policies are usually specified using Local preference attribute, which has a higher priority in the BGP path selection process than the AS-Path length. This represents a scenario that is more realistic than those that are assumed by a basic ASPP trial and error strategy.

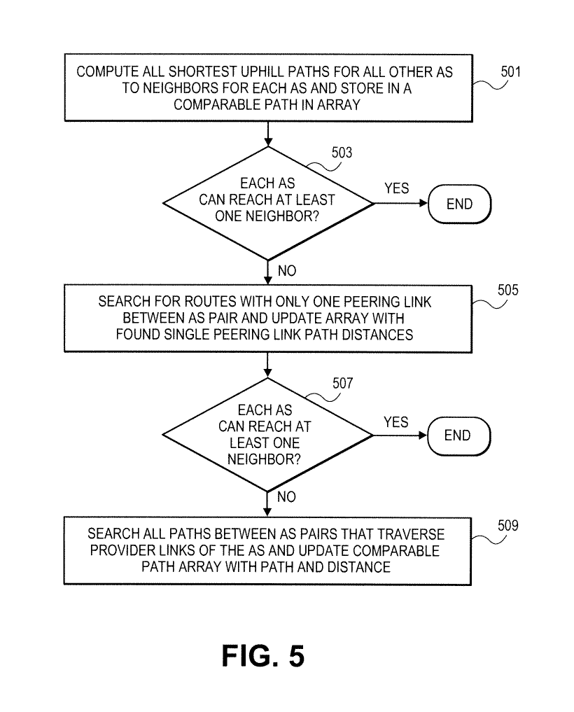

FIG. 5 is a flowchart of one embodiment of a process for identifying comparable paths using the topological information. In one embodiment, this process begins by computing all the shortest uphill paths for all other AS to neighbors for each AS (Block 501). In other words for each (targeted) AS in the network described by the topological data paths are determined to each other AS through at least one neighbor AS of the targeted AS. These paths are stored as a set for further analysis. An uphill path is a path that reaches a target AS through a customer link or set of customer links rather than through provider or peer links. This set of paths is analyzed to ensure that each AS in the network can reach a target AS through at least one of the neighbors of that target AS (Block 503). If each AS can reach at least one neighbor of each target AS, then the process can end and these paths are stored in the comparable path array.

If not all of the AS are reachable to each other AS, a search is made for paths that have only one peering link between them and an update is made to the set of comparable paths in the comparable path array (Block 505). Multiple peering links are not allowed in the paths to ensure the “valley-free” policy is maintained. A check is then made to determine whether the updated comparable path array now provides a path to reach each AS through a neighbor AS of a target AS being analyzed (Block 507). If a path is found to each AS then the process is complete. If not all AS are reachable, then the process continues to look for paths to these AS.

A search is then made of all paths between a set of AS pairs to find paths for those AS pairs that have not found a path with the preceding techniques (Block 509). These paths can traverse provider links and the found links are stored in the comparable paths array. In each of the groups of paths that can be found, uphill paths, single peering link, and remaining paths, multiple paths can be found and added to the comparable paths array that are of the same type.

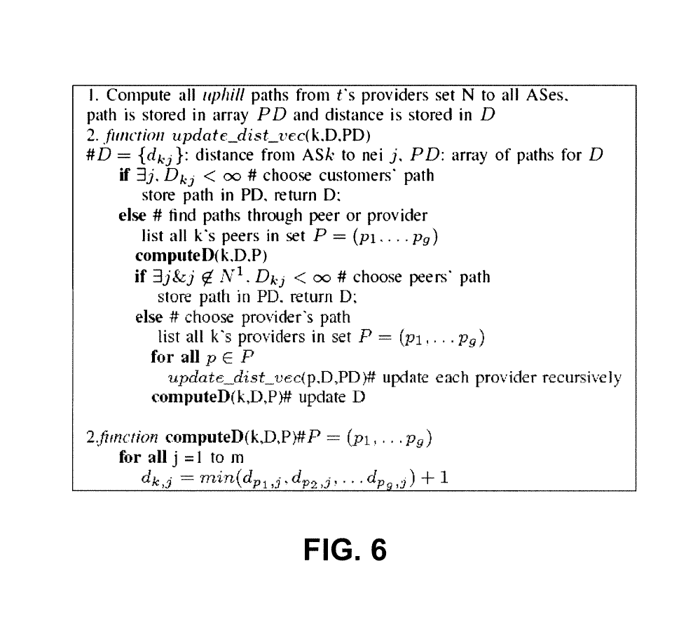

FIG. 6 is a diagram of a process for determining paths for all nodes in a network to a target AS (t). This process corresponds to the process of FIG. 5 described above and can be an alternative implementation thereof. Let I be the set of all ASes on the Internet. A specific target AS t is considered, which will announce a prefix p to its neighbors N={nᵢ}, where N ε 1. N includes both its peers denoted by N₁ and its providers by N₂. Each AS in 1 will receive several paths for prefix p and choose the best one according to the AS path length. By using pre-pending, the target AS t can influence the way in which other ASes will choose the path to reach p. The pre-pending strategy AS t will apply is denoted as Ψ={ψᵢ}, inserting its identifier ψᵢ times in the AS-path of the path announced to neighbor nᵢ. The issue is how to determine the vector ψ given an objective function.

A naive approach would be to compute Ψ by enumerating all possible combinations and simulating the path selection for each combination. However, this approach is not scalable when the set of neighbors is large. Another naïve method is to compute and store all possible paths from all other ASes to the target AS. But then when applying different ψᵢ values, it is not possible to simply count the length of an AS path because the AS relationship may affect the path selection. For instance, from AS k to t, path r₁ has 3 hops and r₂ has 4 hops, through different neighbors. By padding 2 ASNs to r₁, r₂ may not be preferred, because r₂ may go through a provider link while r1 is through a customer link. In this example, r₁ is always preferred over r₂ no matter how the padding is done. In this case, r₁ and r₂ are incomparable with respect to the impact of ASPP. This example demonstrates that not all the paths are comparable, no matter how ASPP is applied. Therefore, there is only a need to keep track of comparable paths and examine an ASPP strategy's impact on them. Two paths are comparable if the preference between them can be changed by a padding action.

FIG. 6 shows one embodiment of the process to compute the sets of comparable paths across all N neighbors. The links in the AS topology are classified to be customer links, provider links and peer links. A path which only follows customer paths is called an uphill path. An AS path “valley-free” policy permits AS paths in the form of customer to provider*, peer to peer?, provider to customer*, where “*” represents zero or more occurrence of such type of AS edge and “?” represents at most one occurrence. Following this rule, the process starts with the computation of the shortest uphill paths from the source node.

An |I|×|N| array D (i.e., the comparable path array) is used to keep all the best comparable paths between t's neighbors in N and all other ASes in I. We first compute the shortest uphill paths from I to N in step 1. The function update dist vec(k,D,PD) updates the distance from AS k to neighbors N according to AS relationship based policy. The uphill path contains only the customer-to-provider (i.e., customer) links. These links are always preferred over peer links and provider links. Even if there was a much shorter path via peering link compared to an uphill path, the former would not be selected. If an AS can reach any of N, i.e., ∃j,Dkj<∞, the search can stop because these paths will always be preferred. Otherwise, for the remaining ASes that cannot reach N, a search is made for a path via one peering link and an update is made to distance matrix D. It should be noted that if the path has already traversed one peering link from t to N₁, then it cannot go through another peering link, according to the “valley-free” policy. Similarly, if a node still does not have a path via customer links and peer links, we search all its provider links (e.g., recursively).

The function computed (k,D,P) computes the distance in D from AS k to neighbors N through k's providers or peers in P. It should be noted that the process considers the effectiveness of the AS-Path pre-pending technique together with the effect of general routing policies. The local routing policies are usually specified using Local preference attribute, which has a higher priority in the BGP path selection process than the AS-Path length. The process is designed to be much closer to realistic scenarios. The path matrix PD and distance matrix D now contain the best paths and their distances from all ASes to t's neighbors N. It should be noted that PD only contains comparable paths, meaning that the pre-pending may affect the selection between them. In the previous example, only r₁ will be kept in the matrix PD. Next PD and D to compute Ψ={ψᵢ}. The assignment differs in details according to different objectives.

### Performing Load Balancing

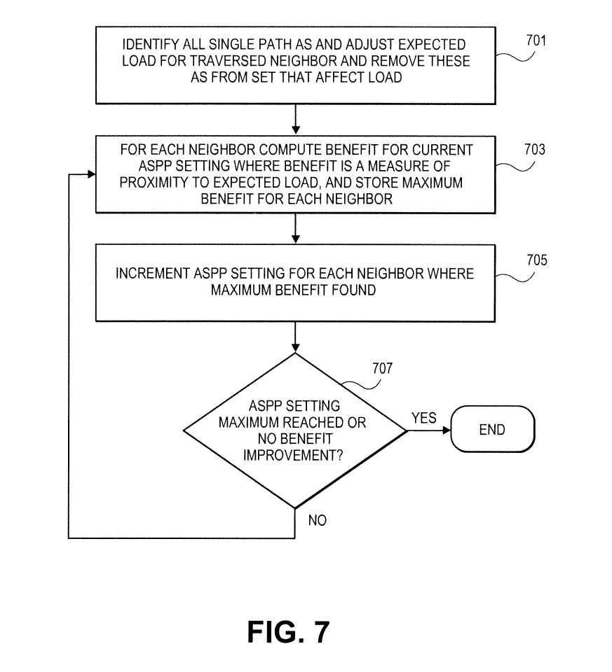

FIG. 7 is a flowchart of one embodiment of the process for determining an ASPP vector for load balancing. In one embodiment, the process is selected to be performed based on network operator or administrator configuration with the goal of traffic engineering using an ASPP vector for load balancing incoming data traffic from neighboring AS's. The process identifies all single path AS and adjusts expected load for traversed neighbor (Block 701). A single path AS is a path to an AS that is reachable from the AS of the router implementing the load balancing. However, since there is only a single path to the reachable AS, the load associated with this AS cannot be moved around for balancing purposes and is simply allotted as is. These single path AS's are removed from the set of paths to be considered for load balancing.

The process continues by computing a benefit for each neighbor for the current ASPP setting (starting at a default value) where the benefit is a measure of proximity to an expected load (Block 703). In other words, a measurement is made of how close the current load distribution with a default ASPP is to having a desired balance. The maximum benefit is stored for each neighbor node of the target node being analyzed.

The current or default ASPP is then incremented or one of the values in the ASPP vector is incremented for each neighbor where a maximum benefit has been detected (Block 705). A check is then made to determine whether an ASPP setting maximum has been reached for each ASPP setting corresponding to each neighbor of the AS being monitored or whether no benefit improvement is found. If all maximum have been reached or there are no new benefit improvements then the process ends. Otherwise, the process can restart.

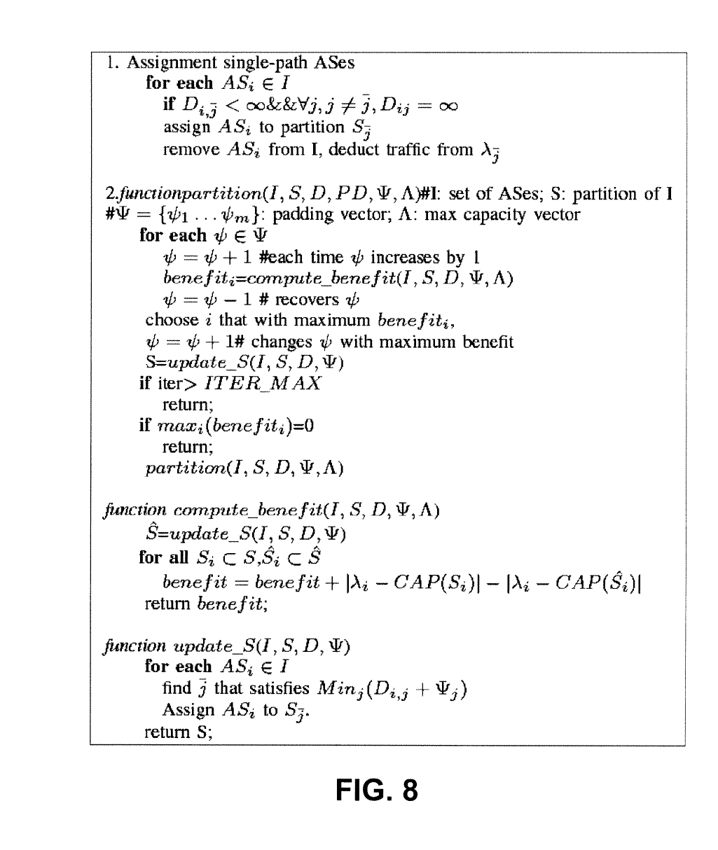

FIG. 8 is a diagram of another embodiment of the load balancing process expressed in a more mathematical example. The terms and variables are consistent here with those mentioned above in regard to the previous example. One common purpose of ASPP based traffic engineering is to balance the load across multiple providers and peers. Different providers may have different price and service level agreement. The operators in target AS t may have their own metrics in determining how much traffic shall traverse through which neighbor. An assumption is made that the goal of traffic distribution among N is known Λ={λᵢ}. The operator adds ψᵢ instances of padding at an advertised path to neighbor i until the AS-Path length is sufficient to reduce/increase the load from neighbor i to the expected value λᵢ.

FIG. 8 presents the process that uses distance matrix D to assign the padding vector Ψ. A partition is made of all ASes(I) into m partitions S={S₁ . . . Sₘ}, according to their best path's first hop AS, t's neighbor N. Some ASes only have a single path to t in matrix D, called single-path AS. For instance, AS0 can only reach t through neighbor 2, then AS₀ can only be assigned to neighbor 2. After assignment, AS₀ is removed from I and deducing the traffic AS₀ generates from the capacity of neighbor 2. This process is shown in Step 1. In step 2, iterative increases of the padding vectors. Each time, a choice is made to increase the ψⱼ that maximize the benefit. After Ψ is updated, the assignment between AS and partition also needs adaptation in function update S. The iteration stops until there is no benefit gain or it reaches the maximum iteration threshold.

### Traversal Avoidance and Provisioning Back-Up Paths

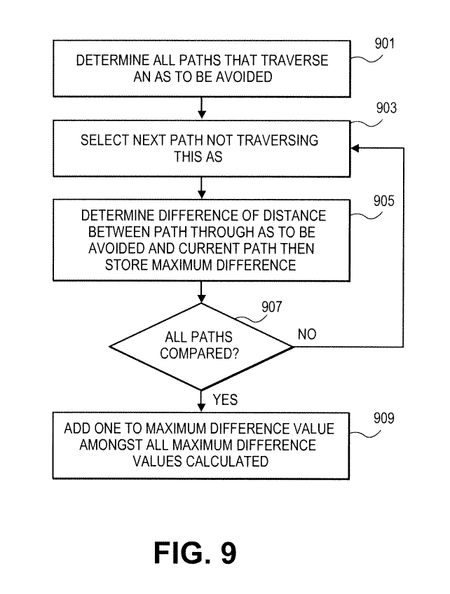

FIG. 9 is a flowchart of one embodiment of a process for traversal avoidance. The process begins by determining all paths in the comparable path array that traverse the target AS to be avoided (Block 901). A selection of a first path that does not traverse the target AS is made (Block 903). A determination is then made of the difference in distance between the selected path and the path through the AS to be avoided. The difference is then stored for further use (Block 905).

A check is then made if all paths have been compared (Block 907). If not, then the process continues by selecting a next path for comparison (Block 903 and 905). However, if all path have been traversed then one is added to a maximum difference value amongst all of the recorded maximum differences, this value is then used as the ASPP value for the corresponding neighbor.

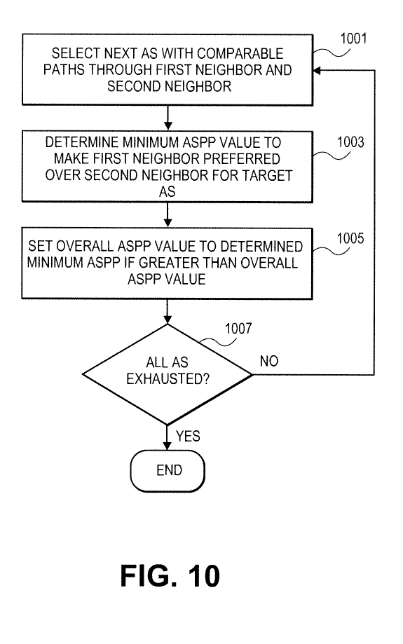

FIG. 10 is a flowchart of one embodiment of a process for back-up path provisioning. The process may initiate with a selection of a next AS in the set of comparable path in the comparable path array, where the comparable paths that are selected from pas through a first neighbor and a second neighbor (Block 1001). A determination is made of the minimum ASPP value to make the first neighbor preferred over the second neighbor of the target AS (Block 1003). An overall ASPP value is set to determine a minimum ASPP if it is greater than an overall ASPP value (Block 1005). A check is then made whether all ASes have been exhausted (Block 1007). If not, then the next AS is selected (Block 1001). If all ASes have been exhausted then the process ends.

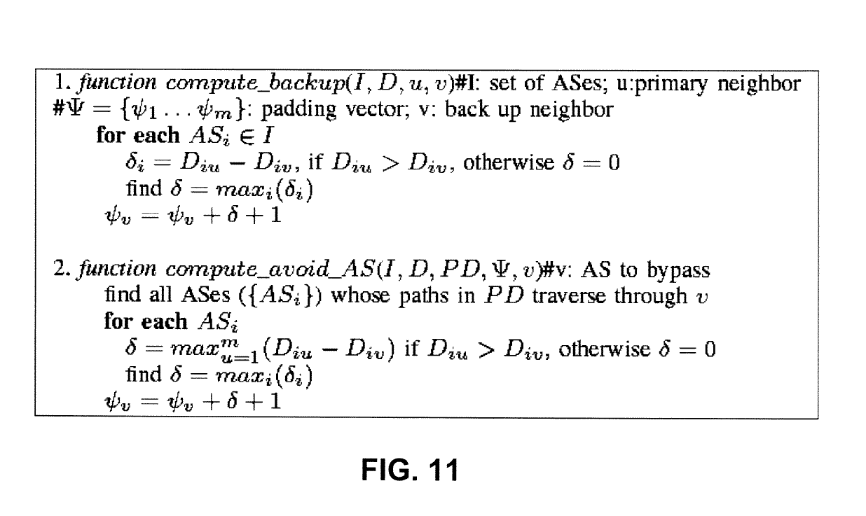

FIG. 11 is a diagram of another embodiment of a padding vector computation for back-up path and avoiding AS. For the purpose of provisioning back-up paths, the degree of padding is usually large enough so that the back-up path will not be adopted as best path unless if there is a failure in other primary paths. In this scenario, the sufficient Ψ is computed to ensure that a path is only used as a back-up path of another. The first function in FIG. 11, compute back-up (I,D, u, v), computes the padding value to ensure that neighbor v will only be used as a back-up for neighbor u. It simply searches the differences of δ=Dᵢᵤ−Dᵢᵥ for all cases v is preferred. The minimum padding value needed to make v less preferred in all ASes is one plus the maximum value of δ.

FIG. 11 is also a diagram of another embodiment of traversal avoidance. Due to business reasons or political factors, the network operators may want to avoid traffic traversing a particular AS. For instance, the countries known with information censorship issues are likely to be such examples. Using the computed path from the algorithm in FIGS. 5 and 6, all the comparable paths are recorded to t in PD. Searching through all paths in PD, a subset of them is taken that is traversing v, the AS to bypass. Similarly, the sufficient padding value is computed from the maximum difference between path through v and all other paths.

The automatic and systematic ASPP process discovers and stores comparable paths between all ASes to the target AS's neighbors. Then the stored path information is used to estimate the most suitable padding vector for three different traffic engineering (TE) goals. The Border Gateway Protocol (BGP) community attribute can be used in order to control the routing policy in its upstream service provider network. While communities themselves do not alter the BGP decision making process, communities can be used as flags in order to mark a set of paths. Upstream service provider routers can then use these flags to apply specific routing polices (for example, local preference) within their network.

Providers establish a mapping between customer configurable community values and the corresponding local preference values within the provider network. The idea is that customers with specific policies that require the modification of LOCAL_PREF in the provider network set the corresponding community values in their routing updates. A community is a group of prefixes that share some common property and can be configured with the BGP community attribute. The BGP Community attribute is an optional transitive attribute of variable length. The attribute consists of a set of four octet values that specify a community. The community attribute values are encoded with an Autonomous System (AS) number in the first two octets, with the remaining two octets defined by the AS. A prefix can have more than one community attribute. A BGP speaker that sees multiple community attributes in a prefix can act based on one, some or all the attributes. A router has the option to add or modify a community attribute before the router passes the attribute on to other peers. In order to learn more about the community attributes.

This gives our algorithm the potential to control the routing policy within the service provider network the community values are changed for the prefixes announced to the service provider. More specifically, the outcome of the previous three algorithms can all be translated to a set of community attributes, designed according to different neighbor's definition of community attributes. In this case, even a single-home provider AS can use our algorithms to perform traffic engineering amongst its provider's neighbors using the pre-computed AS pre-pending schemes. The provider AS will run the algorithm for each of its neighbor separately. The AS t in Figure can be any of the provider AS neighbors. Then the provider AS will construct the community attributes based on the neighbor's definition of the community attributes and the number of ASNs that should be pre-pended.

AS Path pre-pending is a common approach for inter-domain traffic engineering. It relies on manipulating the AS path length by purposely inserting its own ASN multiple times. In the above embodiments, the method and system for computing the optimal ASPP vectors for the operators is discussed. There are three benefits of the method and system 1. The AS Path Pre-pending strategy is based on the prediction on the path selection on all ASes in the Internet. There is no requirement on local ingress/egress traffic matrixes, which is hard to estimate as traffic changes fast. 2. The strategy proposed in this method and system takes into consideration the global picture. 3. The method of generating comparable paths considers the impact of AS relationship based local policies on ASPP's effectiveness. This is one of the key distinguishing points. With this enhancement, our model is much more realistic than any of the models in the related work. We have evaluated the accuracy of this method compared to the observed path selection on the Internet and we observed high accuracy. 4. The algorithm can be used for three objectives, i.e. traffic load balancing, back-up path provisioning, and specific AS bypassing. 5. The method and system are to implement the output of these processes using BGP community attributes, which makes these methods more general and can be even applied for single-homed provider AS's.

With the automated process of controlling on the propagation of the announcements could be used for: 1. Balancing the incoming traffic from the upstream providers, to improve performance or to shape the traffic according to the cost of the links. 2. Letting a large portion of the incoming traffic to use a specific transit Autonomous System (AS) that is known to be reliable and/or with high bandwidth availability. 3. Improving the distribution of the internal traffic flows of a provider As. The method and system changes the current situation that provider AS's perform AS Path pre-pending by trial-and-error, which may take some time to converge to a desirable ASPP configuration and in the meantime make real customer traffic try out different paths. The method and system can be used by our customers to practice ASPP systematically for different purposes.

Thus, a method, system and apparatus for automatic and systematic ASPP vector determination has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method implemented in a network element to determine an autonomous system (AS) path pre-pending (ASPP) vector for an AS of the network element that accounts for AS business relationship induced policies and global impact of ASPP decisions by using comparable paths between AS in a network for application of network management strategies, the comparable paths grouped by path types defined by local preference polices, the method comprising the steps of:
gathering AS level topological data for the network from a border gateway protocol (BGP) table of the network element;
categorizing AS link relationships in the topological data as peer links, customer links and provider links;
computing the comparable paths for each AS pair, the comparable paths for an AS pair sharing a path type defined by the local preference policies and a best path amongst the comparable paths for the AS pair being affected by ASPP; and
applying any one of a load balancing process, back-up path provisioning process or traversal avoidance process to the comparable paths to determine an ASPP vector for the AS of the network element.

2. The method of claim 1, further comprising the steps of:
retrieving BGP updates messages from public servers to be used in the AS level topological data.

3. The method of claim 1, wherein computing the comparable paths for each AS pair comprises the steps of:
computing all shortest uphill paths between neighbors of each AS and all other AS; and
storing the shortest uphill paths in a comparable paths array.

4. The method of claim 3, wherein computing the comparable paths for each AS pair further comprises the step of:
checking whether each AS can be reached by each other AS through at least one neighbor AS.

5. The method of claim 4, wherein computing the comparable paths for each AS pair further comprises the step of:
searching for paths with only one peering link between an AS pair; and
updating the comparable paths array with found single peering link path distances.

6. The method of claim 5, wherein computing the comparable paths for each AS pair further comprises the steps of:
searching all paths between AS pairs that traverse provider links; and
updating the comparable paths array with found provider link path distances.

7. The method of claim 1, wherein the load balancing process comprises the steps of:
identifying all single path AS pairs;
adjusting an expected load for a neighbor traversed by single path AS pairs; and
removing non-target AS in AS pair from set of AS that affect load for a target AS.

8. The method of claim 7, wherein the load balancing process comprises the steps of:
computing a benefit for a current ASPP setting for each neighbor of the target AS, where the benefit is a measure of proximity to expected load; and
storing a maximum benefit for each neighbor of the target AS.

9. The method of claim 8, wherein the load balancing process comprises the steps of:
incrementing the current ASPP setting for each neighbor where a maximum benefit has been found; and
checking whether ASPP setting maximum reached or whether no maximum benefit has been found.

10. The method of claim 1, wherein the back-up provisioning process comprises the step of:
selecting a next AS with comparable paths through a first neighbor and a second neighbor of a target AS.

11. The method of claim 10, wherein the back-up provisioning process comprises the step of:
determining minimum ASPP value to make first neighbor preferred path over second neighbor path for target AS.

12. The method of claim 11, wherein the back-up provisioning process comprises the step of:
setting overall ASPP value to the determined minimum ASPP value if the determined minimum ASPP value is greater than the overall ASPP value.

13. The method of claim 1, wherein traversal avoidance process comprises the step of:
determining all paths that traverse an AS to be avoided;
selecting a next path that does not traverse the AS to be avoided;
determining difference in distance between paths through the AS to be avoided and selected path; and
storing a maximum difference value determined for selected path.

14. The method of claim 1, wherein traversal avoidance process comprises the step of:
incrementing maximum difference value amongst all maximum difference values calculated; and
storing the incremented maximum difference value as ASPP value.

15. A network element to determine an autonomous system (AS) path pre-pending (ASPP) vector for an AS of the network element that accounts for AS business relationship induced policies and global impact of ASPP decisions by using comparable paths between AS in a network for application of network management strategies, the comparable paths grouped by path types defined by local preference polices, the method comprising the steps of:
an ingress module to receive data traffic from the network;
an egress module to transmit data traffic on the network; and
a network processor coupled to the ingress module and egress module the network processor to execute a BGP module and an ASPP module,
the BGP module to maintain a border gateway protocol (BGP) routing table and exchange BGP update messages with other network elements,
the ASPP module to execute
an AS topological module that gathers AS level topological data for the network from the BGP table,
a link categorization module to categorize AS link relationships in the topological data as peer links, customer links and provider links, and
a comparable path module to compute the comparable paths for each AS pair, the comparable paths for an AS pair sharing a path type defined by the local preference policies and a best path amongst the comparable paths for the AS pair being affected by ASPP,
the ASPP module to execute any one of a load balancing module, back-up path provisioning module or traversal avoidance module to the comparable paths to determine an ASPP vector of the AS of the network element.

16. The network element of claim 15, further wherein the AS topological module retrieves BGP updates messages from public servers to be used in the AS level topological data.

17. The network element of claim 15, wherein the comparable path module computes all shortest uphill paths between neighbors of each AS and all other AS, and stores the shortest uphill paths in a comparable paths array.

18. The network element of claim 17, wherein the comparable path module checks whether each AS can be reached by each other AS through at least one neighbor AS.

19. The network element of claim 18, wherein the comparable path module searches for paths with only one peering link between an AS pair, and updates the comparable paths array with found single peering link path distances.

20. The network element of claim 19, wherein comparable path module searches all paths between AS pairs that traverse provider links, and updates the comparable paths array with found provider link path distances.

21. The network element of claim 15, wherein the load balancing module identifies all single path AS pairs, adjusts an expected load for a neighbor traversed by single path AS pairs, and removes non-target AS in AS pair from set of AS that affect load for a target AS.

22. The network element of claim 21, wherein the load balancing module computes a benefit for a current ASPP setting for each neighbor of the target AS, where the benefit is a measure of proximity to expected load, and stores a maximum benefit for each neighbor of the target AS.

23. The network element of claim 22, wherein the load balancing module increments the current ASPP setting for each neighbor where a maximum benefit has been found, and checks whether ASPP setting maximum reached or whether no maximum benefit has been found.

24. The network element of claim 23, wherein the back-up provisioning module selects a next AS with comparable paths through a first neighbor and a second neighbor of a target AS.

25. The network element of claim 24, wherein the back-up provisioning module determines a minimum ASPP value to make a first neighbor preferred path over a second neighbor path for the target AS.

26. The network element of claim 25, wherein the back-up provisioning module sets an overall ASPP value to the determined minimum ASPP value if the determined minimum ASPP value is greater than the overall ASPP value.

27. The network element of claim 26, wherein the traversal avoidance module determines all paths that traverse an AS to be avoided, selects a next path that does not traverse the AS to be avoided, determines a difference in distance between paths through the AS to be avoided and selected path, and stores a maximum difference value determined for selected path.

28. The network element of claim 27, wherein the traversal avoidance module increments maximum difference value amongst all maximum difference values calculated, and storing the incremented maximum difference value as ASPP value.
